(19) United States
(12) Patent Application Publication
(10) Pub. No.: US 2009/0175501 A1
(43) Pub. Date: Jul. 9, 2009

(54) Imaging control apparatus and imaging control method

(75) Inventor: Tomonori Tahara, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/319,355

(22) Filed: Jan. 6, 2009

(30) Foreign Application Priority Data
Jan. 7, 2008 (JP) P2008-000549

(51) Int. Cl. G06K 9/00; H04N 7/14

(52) U.S. Cl. 382/103; 348/14.08; 348/E05.001

(57) ABSTRACT

An imaging control apparatus includes preset information management means for holding and managing unit preset information including positional information indicative of the position of an imaging field changing mechanism that changes the imaging field of view of an imaging unit, and reference image data, the preset information management means, as a registration process in response to a registration instruction, producing and holding unit preset information including positional information indicative of the position of the imaging field changing mechanism when the registration instruction is issued and reference image data related to the positional information and produced based on an image signal obtained through imaging performed by the imaging unit when the registration instruction is issued; operation screen display control means for controlling display of an operation image used to select among preset items that correspond to respective sets of unit preset information held in the preset information management means, the operation screen display control means displaying and presenting, for each of the preset items, the reference image data contained in the corresponding unit preset information on the operation screen; and drive control means for carrying out drive control for changing the position of the imaging field changing mechanism, the drive control means carrying out the drive control in such a way that when a preset item is selected and entered on the operation screen, the imaging field changing mechanism is positioned as indicated by the positional information in the unit preset information that corresponds to the selected and entered preset item.

### CROSS REFERENCES TO RELATED APPLICATIONS

The present invention contains subject matter related to Japanese Patent Application JP 2008-000549 filed in the Japanese Patent Office on Jan. 7, 2008, the entire contents of which being incorporated herein by reference.

### BACKGROUND OF THE INVENTION

1. Field of the Invention

The present invention relates to an imaging control apparatus and an imaging control method capable of changing the imaging field of view of an imaging apparatus by controlling pan, tilt and zoom mechanisms.

2. Description of the Related Art

In a teleconference system, terminal apparatus that support the teleconference system are provided in respective conference halls or other places remote from one another, and each of the terminal apparatus is connected to an imaging apparatus and a display apparatus. In a near-end conference hall, a picked-up image obtained by using the imaging apparatus to image conference participants or other objects in the conference hall is transmitted via the terminal apparatus to the terminal apparatus in a far-end different conference hall. The far-end terminal apparatus receives the picked-up image transmitted from the near end and displays it on the display apparatus connected to the terminal apparatus.

Each of the terminal apparatus is also connected to a microphone and a loudspeaker, and a signal containing audio from a near-end speaker picked up by the near-end microphone is transmitted to the far end via the terminal apparatus. The far-end terminal apparatus receives the audio signal and outputs it from the loudspeaker.

In such a teleconference system, the conference can proceed in such a way that conversation takes place while the display apparatus displays images picked up in the conference hall on the communication counterpart side.

In a teleconference system, the imaging field of view imaged by the imaging apparatus is preferably changed in some cases as the conference proceeds. For example, whenever a conference participant speaks, the speaking conference participant (speaker) is preferably zoomed up. In such a case, an imaging apparatus configured to carry out imaging, for example, with its imaging direction oriented toward a fixed point is unsuitable for the above purpose.

To address the above problem, there is a teleconference system in which an imaging apparatus is combined with a mounting base for what is called pan, tilt, and zoom control. In such a teleconference system, for example, when a new speaker appears, the imaging apparatus can image as appropriate the speaker with the imaging field of view set to include the speaker by carrying out as appropriate pan, tilt, and zoom motion instruction operations (panning, tilting, and zooming).

Further, a teleconference system has a pan, tilt, and zoom preset function in which a specific imaging field of view determined by a combination of pan, tilt, and zoom positions is set and stored in advance and any one of the combinations is called up through a predetermined operation.

In the preset function, for example, in response to selecting and entering a desired preset number, the pan and tilt mechanisms in the mounting base and the zoom mechanism in the imaging apparatus are driven and controlled to achieve the pan, tilt, and zoom positions set for the preset number. In this way, for example, whenever a speaker appears one after another, only selecting and entering a preset number allows the imaging field of view to be automatically changed in such a way that the speaker is zoomed up in a picked-up image.

JP-A-2001-128057 describes an example of the pan, tilt, and zoom control.

### SUMMARY OF THE INVENTION

It is desirable to provide a more user-friendly preset function for changing the imaging field of view described above implemented in a teleconference system or any other similar system.

In consideration of the problems described above, an imaging control apparatus according to an embodiment of the invention is configured as follows.

The imaging control apparatus includes preset information management means for holding and managing unit preset information including positional information indicative of the position of an imaging field changing mechanism that changes the imaging field of view of an imaging unit, and reference image data, the preset information management means producing and holding, as a registration process in response to a registration instruction, unit preset information including positional information indicative of the position of the imaging field changing mechanism when the registration instruction is issued and reference image data related to the positional information and produced based on an image signal obtained through imaging performed by the imaging unit when the registration instruction is issued; operation screen display control means for displaying an operation image used to select among preset items that correspond to respective sets of unit preset information held in the preset information management means, the operation screen display control means displaying and presenting, for each of the preset items, the reference image data contained in the corresponding unit preset information on the operation screen; and drive control means for carrying out drive control for changing the position of the imaging field changing mechanism, the drive control means carrying out the drive control in such a way that when a preset item is selected and entered on the operation screen, the imaging field changing mechanism is positioned as indicated by the positional information in the unit preset information that corresponds to the selected and entered preset item.

The “imaging field of view” used herein corresponds to, for example, the range of an image picked up by the imaging apparatus with surrounding objects removed. The “imaging field of view” changes when the imaging direction of the imaging apparatus is moved in the pan or tilt direction. The “imaging field of view” also changes when the angle of view (zoom) of the imaging apparatus is changed.

The “position of an imaging field changing mechanism” used herein is the position of a movable portion of the imaging field changing mechanism. For the pan and tilt mechanisms, for example, the position thereof can be expressed by the angle of rotation with reference to a predetermined position. For the zoom mechanism, the position thereof can be expressed by the position of a zoom lens. Each of the pan, tilt, and zoom mechanisms is driven by a motor, so that the position thereof can also be obtained from the information on the rotational position of the motor.

According to the above configuration, the operation screen, on which preset items that correspond to respective sets of unit preset information are displayed, appears and displays images based on the reference image data that correspond to the respective sets of unit preset information in correspondence with the preset items. Each of the reference image data forms an image within the imaging field of view imaged by the imaging apparatus when a preset registration instruction operation is carried out.

In the embodiment of the invention, looking at the operation screen thus allows a user to visually understand how the imaging field of view is set for each of the preset items. For example, as compared to a case where each preset item simply presents only a preset number, selecting a preset imaging field of view is more readily understood, whereby the user-friendliness is improved accordingly.

### BRIEF DESCRIPTION OF THE DRAWINGS

FIG. 1 shows an exemplary configuration of a teleconference system according to an embodiment of the invention;

FIG. 2 shows an exemplary internal configuration of a teleconference terminal apparatus of the present embodiment along with an imaging apparatus and a display apparatus connected to the teleconference terminal apparatus;

FIG. 3 explains a GUI for a PTZ preset function achieved in the configuration of the teleconference system of an embodiment;

FIG. 4 explains a PTZ preset GUI according to a first embodiment;

FIG. 5 shows an exemplary structure of preset information according to an embodiment (first embodiment);

FIGS. 6A and 6B explain new registration of unit preset information in the embodiment (first embodiment);

FIG. 7 is a flowchart showing an exemplary process procedure carried out by the teleconference terminal apparatus in relation to registration and call-up of PTZ preset information according to the first embodiment;

FIG. 8 is a flowchart showing an exemplary procedure for displaying a PTZ preset image;

FIGS. 9A and 9B explain actions of updating a thumbnail image in response to a preset selection operation according to a second embodiment;

FIG. 10 is a flowchart showing an exemplary process procedure carried out by the teleconference terminal apparatus in relation to registration and call-up of PTZ preset information according to the second embodiment;

FIG. 11 is a flowchart showing an exemplary procedure for updating preset information according to a third embodiment;

FIG. 12 shows an exemplary structure of preset information contained in a near-end teleconference terminal apparatus and a far-end teleconference terminal apparatus according to a fourth embodiment; and

FIG. 13 is a flowchart showing an exemplary procedure for allowing the near-end teleconference terminal apparatus to control panning, tilting, and zooming in the far-end teleconference terminal apparatus according to the fourth embodiment.

### DESCRIPTION OF THE PREFERRED EMBODIMENTS

As the best mode for carrying out the invention (hereinafter referred to as an embodiment), the invention is applied to a video transceiver in a television conference system (teleconference system).

The teleconference system is configured in such a way that teleconference terminal apparatus, each of which is a communication terminal, are installed in conference halls in different places, and a teleconference terminal apparatus transmits an image picked up by an imaging apparatus and audio picked up by a microphone to a teleconference terminal apparatus in a different place, receives an image and audio transmitted from the teleconference terminal apparatus in the different place, and outputs them on a display apparatus and from a loudspeaker, respectively. That is, the teleconference system includes a video transceiver that transmits and receives images back and forth, and an audio transceiver that transmits and receives audio back and forth. The present embodiment corresponds to a system having a core teleconference terminal apparatus as the video transceiver provided to transmit and receive a picked-up image.

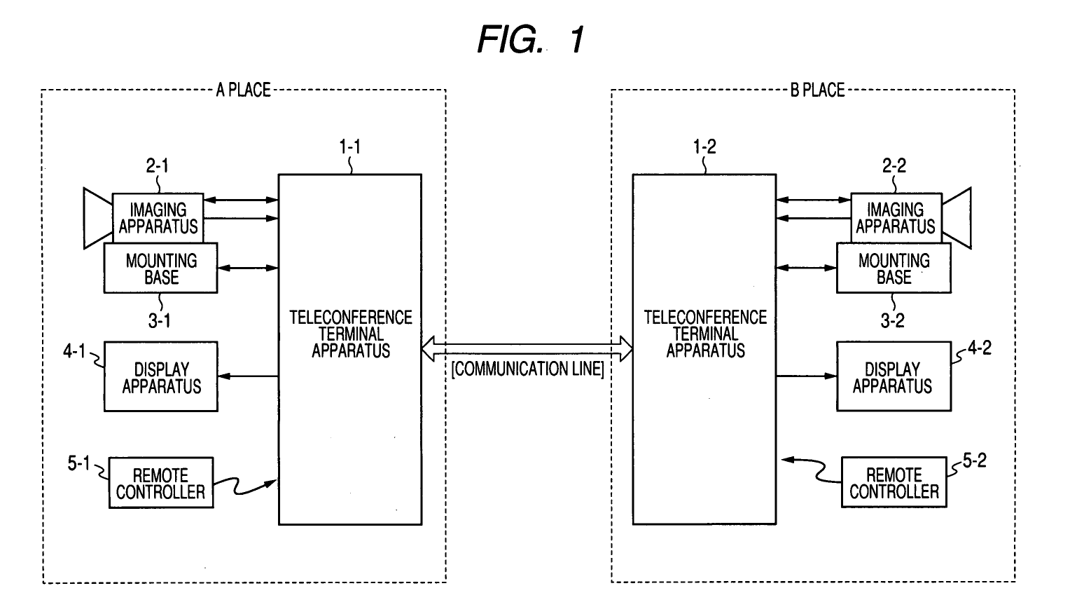

FIG. 1 shows an exemplary system configuration focused on a video transceiver in a teleconference system.

In this case, two places A and B remote from each other are conference halls, and teleconference terminal apparatus 1-1 and 1-2 are installed in the places A and B, respectively. The teleconference terminal apparatus 1-1 and 1-2 are connected to each other by a communication line that supports a predetermined communication scheme for two-way communication.

In the place A, an imaging apparatus 2-1, a mounting base 3-1, and a display apparatus 4-1 as well as the teleconference terminal apparatus 1-1 are provided.

The imaging apparatus 2-1 is equipped with a zoom mechanism for adjusting the angle of view and attached to the mounting base 3-1. The mounting base 3-1 includes a pan mechanism and a tilt mechanism so that the imaging direction (imaging field of view) of the attached imaging apparatus can be changed within a predetermined range in the up-down direction and the right-left direction.

Also provided is a remote controller 5-1 by which a user remotely operates the action of the teleconference terminal apparatus 1-1.

Similarly, in the place B, an imaging apparatus 2-2, a mounting base 3-2, and a display apparatus 4-2 as well as the teleconference terminal apparatus 1-2 are provided.

In the following description, when it is not particularly necessary to distinguish among the teleconference terminal apparatus, imaging apparatus, mounting bases, display apparatus, and remote controllers installed in separate places, they will be called teleconference terminal apparatus 1, imaging apparatus 2, mounting bases 3, display apparatus 4, and remote controllers 5.

An audio transceiver is not illustrated in FIG. 1.

Basic actions of the video transceiver shown in FIG. 1 are, for example, summarized as follows:

First, in the place A, a video signal containing motion images picked up by the imaging apparatus 2-1 is inputted to the teleconference terminal apparatus 1-1. The teleconference terminal apparatus 1-1 transmits the inputted video signal to the teleconference terminal apparatus 1-2 through the communication line. The teleconference terminal apparatus 1-2 receives the thus transmitted video signal and outputs it on the display apparatus 4-2.

Similarly, the teleconference terminal apparatus 1-2 transmits a video signal picked up by the imaging apparatus 2-2 in the place B to the teleconference terminal apparatus 1-1. The teleconference terminal apparatus 1-1 outputs the received video signal on the display apparatus 4-1.

The video transceivers in the teleconference system thus carry out two-way video communication, whereby a conference participant present in a certain place, for example, can visually understand how the conference in another place proceeds. For example, when an imaging apparatus 2 in a conference hall is imaging a present speaker in such a way that the imaging field of view is set to zoom up the speaker, a display apparatus 4 in another conference hall displays an image including the zoomed-up speaker.

The “imaging field of view” used herein corresponds to, for example, the range of an image actually picked up within an imageable range of the imaging apparatus 2 with surrounding objects removed. The “imaging field of view” changes when the imaging direction of the imaging apparatus is moved in the pan or tilt direction. The “imaging field of view” also changes when the angle of view (zoom) of the imaging apparatus is changed.

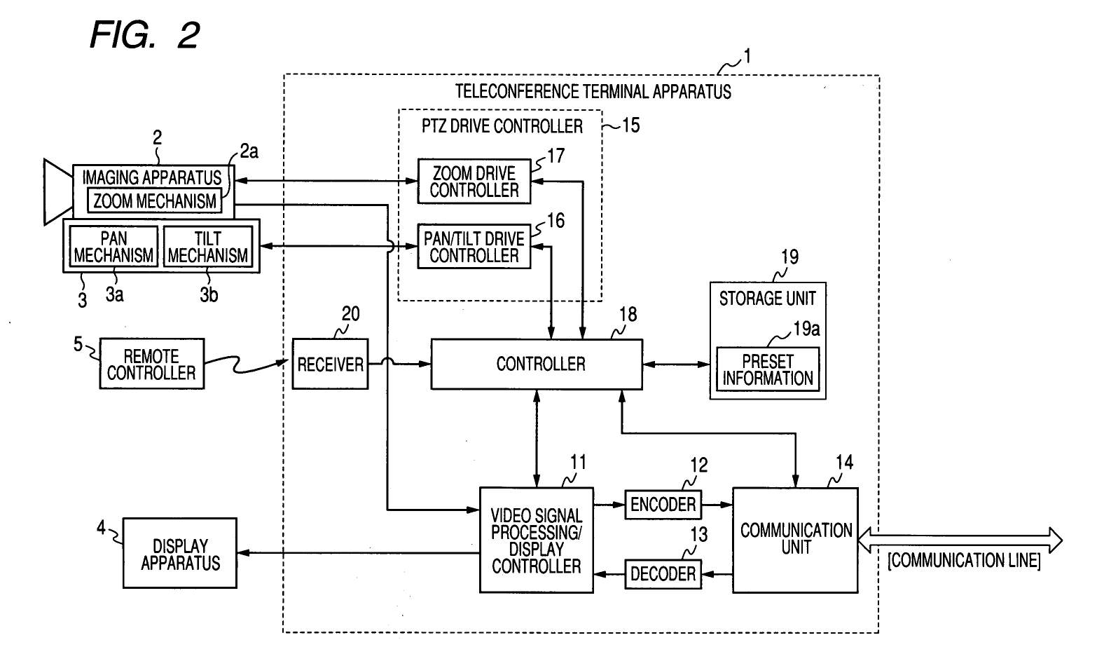

FIG. 2 shows a teleconference system installed in a single place, along with an exemplary internal configuration of the teleconference terminal apparatus 1. In relation to FIG. 1, each of the teleconference terminal apparatus 1-1 and 1-2 can be considered to have the same configuration shown in FIG. 2. In FIG. 2, the portion that corresponds to the audio transceiver is not illustrated.

The imaging apparatus 2 in this case includes an imaging optical system and a signal processor that uses image light to produce a video signal containing non-compressed motion images. The video signal (picked-up video signal) outputted from the imaging apparatus 2 is inputted to a video signal processing/display controller 11 in the teleconference terminal apparatus 1.

The optical system of the imaging apparatus 2 is equipped with a zoom mechanism 2a that moves the position of a zoom lens to change the angle of view.

The mounting base 3 includes a pan mechanism 3a that changes the imaging field of view of the imaging apparatus 2 attached to the mounting base 3 in the right-left direction and a tilt mechanism 3b that changes the imaging field of view in the up-down direction.

The video signal processing/display controller 11 performs predetermined signal processing on the inputted video signal as required and performs display control for displaying an image on the display apparatus 4.

For example, the video signal processing/display controller 11 performs necessary signal processing on the picked-up video signal inputted from the imaging apparatus 2 as required and then transfers the resultant signal to an encoder 12.

The encoder 12 performs image compression coding based on a predetermined scheme on the inputted video signal and transfers the resultant signal to a communication unit 14. The communication unit 14 transmits the compressed image data transferred from the encoder 12 to a teleconference terminal apparatus in a different place via the communication line under the control of a controller 18 in accordance with a predetermined communication scheme.

The communication unit 14 receives compressed image data transmitted from the teleconference terminal apparatus in the different place and transfers the compressed image data to a decoder 13.

The decoder 13 performs decoding against the image compression coding on the inputted compressed image data to provide a video signal in a predetermined format. The thus obtained video signal is transferred to the video signal processing/display controller 11.

The video signal processing/display controller 11 can carry out display control for displaying an image, for example, based on the video signal thus transferred from the decoder 13 on the display apparatus 4. In this way, an image picked up in another conference hall is displayed on the display apparatus 4.

The video signal processing/display controller 11 can also carry out display control for displaying the picked-up video signal on the display apparatus 4 in a predetermined format.

Further, the video signal processing/display controller 11 can carry out image generation and display control for displaying a variety of operation images on the display apparatus 4 under the control of the controller 18.

Part or all of the functions of the video signal processing/display controller 11 can be achieved by a DSP (Digital Signal Processor).

The teleconference terminal apparatus 1 has a function of changing the imaging field of view of the imaging apparatus 2. The imaging field of view in this case is changed by controlling pan, tilt, and zoom in combination. In the pan control and the tilt control, the imaging direction of the imaging apparatus (imaging field of view) is changed in the right-left and up-down directions, and in the zoom control, the angle of view of the imaging apparatus is changed. To this end, the teleconference terminal apparatus 1 includes a PTZ (Pan (Panning), Tilt (Tilting), Zoom (Zooming)) drive controller 15.

The PTZ drive controller 15 includes a pan/tilt drive controller 16 and a zoom drive controller 17, as shown in FIG. 2.

The pan/tilt drive controller 16 produces and outputs a drive signal for driving a pan motor in the pan mechanism 3a provided in the mounting base 3 in accordance with instruction information on the amount of movement in the pan direction provided from the controller 18. Similarly, the pan/tilt drive controller 16 produces and outputs a drive signal for driving a tilt motor in the tilt mechanism 3b provided in the mounting base 3 in accordance with instruction information on the amount of movement in the tilt direction provided from the controller 18. It is thus possible to change the imaging direction, as the imaging field of view of the imaging apparatus 2, in the right-left direction (pan direction) and the up-down direction (tilt direction).

The zoom drive controller 17 produces and outputs a drive signal for driving a zoom motor in the zoom mechanism 2a provided in the optical system in the imaging apparatus 2 in accordance with instruction information on the amount of change in angle of view provided from the controller 18. It is thus possible to change the angle of view as the imaging field of view.

The controller 18 includes, for example, a microcomputer including a CPU, a ROM, and a RAM, and controls the entire teleconference terminal apparatus 1.

A storage unit 19 includes, for example, a non-volatile storage device and stores a variety of programs, data, and other information necessary for the controller 18.

As will be described later, the present embodiment has a preset (hereinafter also referred to as PTZ preset) function in which a set of pan, tilt, and zoom positional information necessary to determine a single imaging field of view is registered in advance and called up later. The storage unit 19 stores preset information 19a that corresponds to the PTZ preset function.

The remote controller 5 includes necessary operation members used by a user to carry out a variety of operations to operate the teleconference terminal apparatus 1. The remote controller 5 transmits an operation information signal by means of, for example, infrared light or radio waves in accordance with an operation through any of the operation members. A receiver 20 receives the operation information signal, decodes it, and outputs it to the controller 18. The controller 18 carries out necessary control and processes in response to the inputted operation information signal.

The teleconference terminal apparatus 1 of the present embodiment can change the imaging field of view, that is, the pan, tilt, and zoom positions of the imaging apparatus 2 (panning, tilting, and zooming) as one of the operations performed by the remote controller 5.

Further, with a variety of operation screens displayed on the display apparatus 4, it is possible to carry out any operation on any of the displayed operation screens.

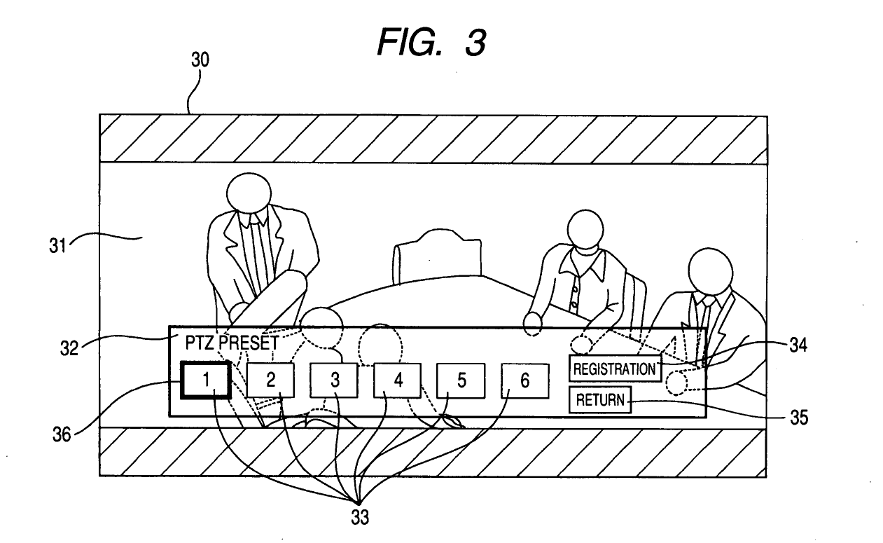

FIG. 3 shows an exemplary PTZ preset operation screen achieved in the teleconference system of the present embodiment shown in FIGS. 1 and 2. Referring to FIG. 3, an example of basic operation procedures and actions of the PTZ preset function will be described.

FIG. 3 shows a display screen 30 on which an image is displayed in the display apparatus 4.

A basic PTZ preset registration operation is registering an imaging field of view imaged by the imaging apparatus 2 installed in a single conference hall. In the following description, a term “near end” may be added in some cases to a component of the teleconference system installed in a conference hall where a user who carries out PTZ preset registration and call-up operations is present. In the following description, operations carried out by the user are made through the remote controller 5 unless otherwise specified.

When the user carries out PTZ preset registration, the user carries out a predetermined operation on the display screen 30 of the near-end display apparatus 4 to display a picked-up image (near-end picked-up image) 31 picked up by the near-end imaging apparatus 2. Thereafter, the user carries out another predetermined operation to display a PTZ preset image 32, as shown in FIG. 3. The PTZ preset image 32 is an operation screen through which preset registration and preset call-up operations can be carried out. In this case, the PTZ preset image 32 is superimposed on the near-end picked-up image 31 as a background.

In the PTZ preset image 32 in this case, a predetermined number of preset buttons 33 are disposed, each of which displays a preset number that corresponds to a preset item. In this case, six preset buttons 33 that correspond to preset numbers 1 to 6 are shown.

In the PTZ preset image 32, a registration button 34 and a return button 35 are shown on the right of the preset buttons 33.

Further, a selection indication frame 36 is displayed in the PTZ preset image 32. The position where the selection indication frame 36 is placed is moved to any of the plurality of preset buttons 33 in accordance with a user's operation.

Preset new registration or preset update registration using the PTZ preset image 32 is carried out as follows:

First, the user places the selection indication frame 36 at the preset button 33 on which a preset number the user wants to register is displayed. In this description, as shown in FIG. 3, the selection indication frame 36 is placed at the preset button 33 whose preset number is 1. The user then operates the remote controller 5 to achieve movement in the pan direction, movement in the tilt direction, or change in zoom factor (panning, tilting, or zooming) as appropriate, so that the pan mechanism 3a or the tilt mechanism 3b in the mounting base 3 or the zoom mechanism 2a in the imaging apparatus 2 is moved to provide a desired imaging field of view. During the adjustment, the user can check the state of the imaging field of view by looking at the near-end picked-up image 31 displayed on the display screen 30. Once a desired imaging field of view is obtained, the user carries out a predetermined operation on the remote controller 5 that corresponds to pushing the registration button 34. This operation is a registration instruction operation, that is, registration operation.

In response to the operation on the registration button 34 (registration operation), the controller 18 in the teleconference terminal apparatus 1 relates the pan, tilt, and zoom positional information (PTZ positional information) that has been actually obtained in the registration operation to the preset number 1, which is displayed on the preset button 33 where the selection indication frame 36 is placed in the same registration operation, produces unit preset information that corresponds to the preset number 1, and registers the unit preset information to be included in the preset information 19a in the storage unit 19. When no unit preset information that corresponds to the preset number 1 has been registered in the preset information 19a, the current unit preset information registration is new registration. On the other hand, when any unit preset information that corresponds to the preset number 1 has been registered, the current unit preset information registration is update registration and overwrites the registered unit preset information with the current unit preset information. The PTZ preset registration can be carried out in the procedure described above.

When any PTZ preset information is called up to change the imaging field of view, the PTZ preset image 32 is first displayed on the display screen 30. For example, when the PTZ preset image 32 is displayed for the first time in response to the display operation, the selection indication frame 36 is placed and displayed at the preset button 33 that corresponds to the preset number last selected. In this situation, the user moves the selection indication frame 36 to the preset button 33 showing the preset number to which PTZ positional information that corresponds to a desired imaging field of view has been registered. This operation may be carried out, for example, by forwarding the selection indication frame 36 toward adjacent preset buttons 33, or directly specifying a preset number, for example, through numeric keys.

In response to the operation of thus selecting the preset button 33, that is, the preset number (calling up PTZ preset information), the controller 18 refers to the PTZ positional information contained in the unit preset information that corresponds to the selected preset number, and controls the PTZ drive controller 15 in such a way that the pan mechanism 3a and the tilt mechanism 3b in the mounting base 3 and the zoom mechanism 2a in the imaging apparatus 2 are moved to the pan, tilt, and zoom positions indicated by the PTZ positional information. In this way, the imaging field of view set in advance for the selected preset number can be automatically obtained.

Operating the return button 35 allows, for example, the user to return to the operation screen immediately above the PTZ preset function in the operation screen hierarchy.

In the PTZ preset image 32 shown in FIG. 3, since only preset numbers are displayed on the preset buttons 33, it is difficult to know which preset number corresponds to which imaging field of view (PTZ positional information) unless the user remembers it correctly. To call up PTZ preset information, in practice, the user conventionally guesses and selects a preset button 33, looks at the changed near-end picked-up image 31 after the pan, tilt, and zoom control has been actually carried out in response to the selection, and checks whether it is a desired imaging field of view.

As described above, in the format of the PTZ preset image 32 shown in FIG. 3, the operation of calling up PTZ preset information is cumbersome and not user-friendly. As an alternative operation of calling up PTZ preset information, it is known to directly specify a preset number in an easier manner, for example, by using numeric keys on the remote controller without displaying the PTZ preset image 32. However, in this case as well, since the user does not know which preset number is related to which imaging field of view (PTZ positional information), the user-friendliness is still poor.

In the present embodiment, a PTZ preset GUI, which will be described below, is prepared to solve the above problem.

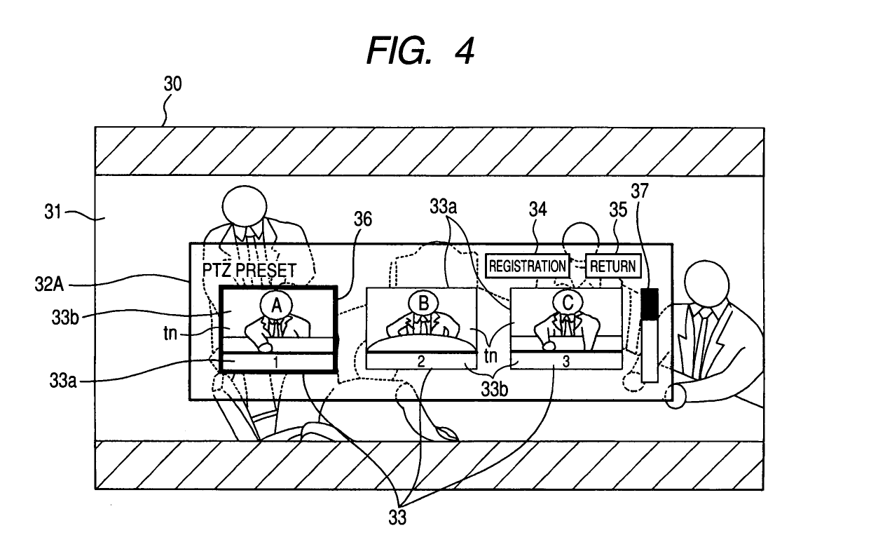

FIG. 4 shows an exemplary display format of a PTZ preset image 32A in the present embodiment. In FIG. 4, the same portions as those in FIG. 3 have the same reference characters.

In the display screen 30 shown in FIG. 4, for example, three preset buttons 33 are displayed in the PTZ preset image 32A displayed on the near-end picked-up image 31 as a background. In practice, when more preset numbers are prepared, the preset buttons 33 that correspond to the preset numbers that may not be displayed in the PTZ preset image 32A can be displayed, for example, by operating a scroll bar 37.

Each of the three preset buttons 33 shown in FIG. 4 includes a lower preset number area 33a and an upper thumbnail area 33b. The preset number area 33a shows the preset number related to that preset button 33, and the thumbnail area 33b displays a thumbnail image tn (reference image). The thumbnail image tn displayed in the thumbnail area 33b is based on a still image acquired from images picked up by the imaging apparatus 2 at the time of the last registration (new registration, update registration). The images picked up by the imaging apparatus 2 at the time of the registration are imaged using the imaging field of view based on the pan, tilt, and zoom positions set at the time of the registration. That is, the thumbnail image tn serves to visually present the imaging field of view to be obtained by calling up the preset number of the preset button 33 on which that thumbnail tn is displayed.

Employing such a display format of the PTZ preset image 32A allows the user who calls up PTZ preset information to visually and immediately know, when the PTZ preset image 32A is displayed, what imaging field of view is related to each preset number. The user then only needs to locate the thumbnail image tn picked up using a desired imaging field of view and select the preset button 33 on which that thumbnail image tn is displayed in the thumbnail area 33b. In this way, in the present embodiment, the user can immediately locate and select the thumbnail image that corresponds to a desired imaging field of view among a plurality of PTZ preset items (preset buttons 33). The operability of calling up (selecting) PTZ preset information is therefore significantly improved as compared to the case shown in FIG. 3.

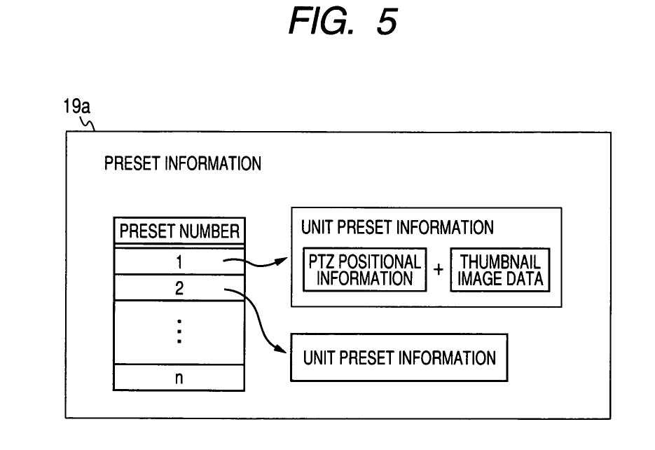

Now, the PTZ preset image 32A of the present embodiment is used to describe a case where PTZ preset information is newly registered. First, FIG. 5 shows an exemplary structure of the preset information 19a stored in the storage unit 19.

FIG. 5 diagrammatically shows the structure of the preset information 19a. As shown in FIG. 5, the preset information 19a has a structure in which unit preset information will be related to each of a predetermined number of preset numbers 1 to n prepared in advance. The unit preset information includes PTZ positional information and thumbnail image data (reference image data). When any unit preset information is related to a preset number, the preset number has been already registered, whereas when no unit preset information is related a preset number, the preset number has not been registered.

The pan, tilt, and zoom positions indicated by the PTZ positional information (positions of the imaging field changing mechanisms) are the positions of movable portions of the pan mechanism 3a, the tilt mechanism 3b, and the zoom mechanism 2a, each of which is the imaging field changing mechanism. For example, the position of each of the pan mechanism 3a and the tilt mechanism 3b can be expressed by an angle of rotation with reference to a predetermined position. The position of the zoom mechanism 2a can be expressed by the position of the zoom lens. Each of the pan mechanism 3a, the tilt mechanism 3b, and the zoom mechanism 2a is moved by a motor, so that the position thereof can also be obtained by the rotational position of the motor.

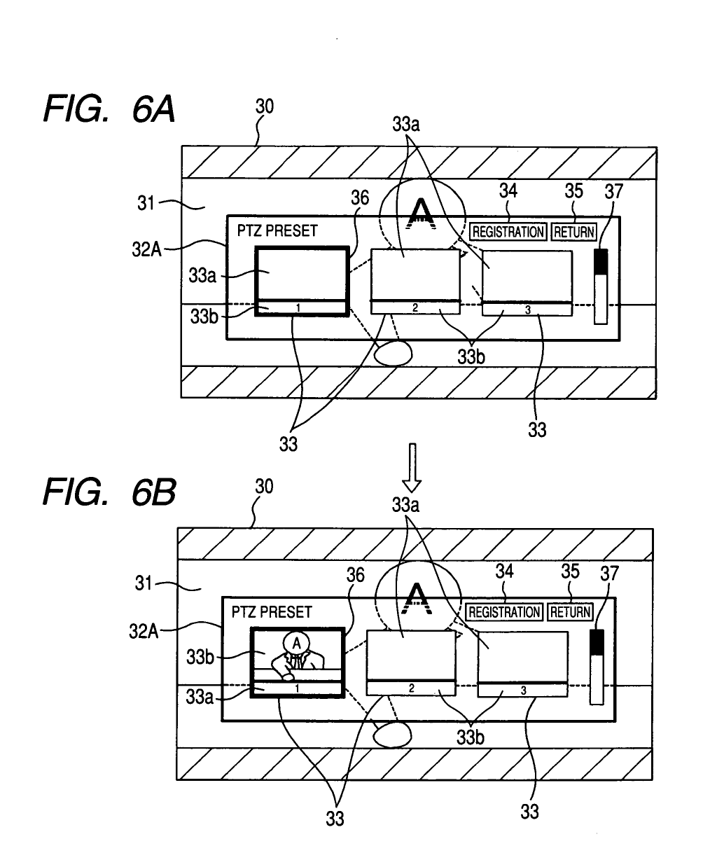

In the display screen 30 shown in FIG. 6A, a PTZ preset image 32A similar to that shown in FIG. 4 is displayed. In FIG. 6A, however, the thumbnail areas 33b of the preset buttons 33 that correspond to the preset numbers 1, 2, and 3 display no thumbnail images tn but blank images. This indicates that no unit preset information has been registered for the preset numbers 1, 2, and 3.

In this situation, a description will be made of a case where the user carries out new registration for the preset number 1. First, if any image other than a near-end picked-up image 31, such as an image picked up on the communication counterpart side, is displayed as the background of the display screen 30, the user switches the displayed image to a near-end picked-up image 31. The near-end picked-up image 31 is used as a monitor image for checking how panning, tilting, and zooming have adjusted the field imaging of view.

The user then places the selection indication frame 36 at the preset button 33 whose preset number is 1, and carries out panning, tilting, and zooming to provide a desired imaging field of view. At this point, the user obtains an imaging field of view in which a conference participant A is zoomed up. Once the imaging field of view is determined, the registration button 34 is pressed (registration operation). This registration operation corresponds to the preset number 1.

In response to this operation, the teleconference terminal apparatus 1 acquires the PTZ positional information at this point, acquires a still image from the images being picked up by the near-end imaging apparatus 2 at the time of the registration, and produces thumbnail image data. A set of the PTZ positional information and the thumbnail image data is then related to the preset number to produce unit preset information, which is then newly registered in the preset information 19a.

Thereafter, a thumbnail image tn using the thumbnail image data contained in the unit preset information described above is displayed in the thumbnail area 33b of the preset button 33 that corresponds to the preset number 1.

Although not described with reference to the drawings, update registration is carried out by first selecting a preset number that have been already registered and then carrying out the registration operation. In the update registration, PTZ positional information at the time of the registration operation and a thumbnail image produced from a still image acquired from the images picked up at the same time are used to newly produce unit preset information. The newly produced unit preset information overwrites the unit preset information that has been related to the preset number being currently registered.

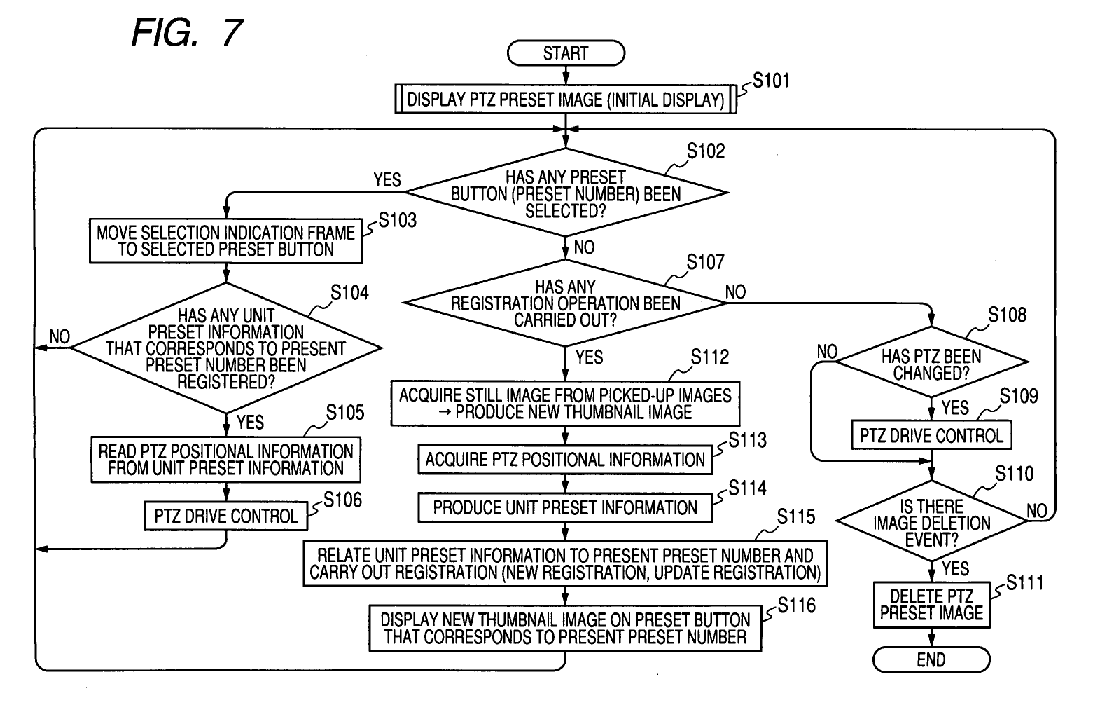

The PTZ preset configuration described with reference to FIGS. 4 to 6A and 6B relates to the first embodiment. The flowchart shown in FIG. 7 shows an exemplary process procedure carried out by the near-end teleconference terminal apparatus 1 in relation to registration and call-up of PTZ preset information according to the first embodiment. It is noted that the operation of displaying a near-end picked-up image 31 as the background image on the display screen can be carried out as appropriate independent of the processes shown in FIG. 7.

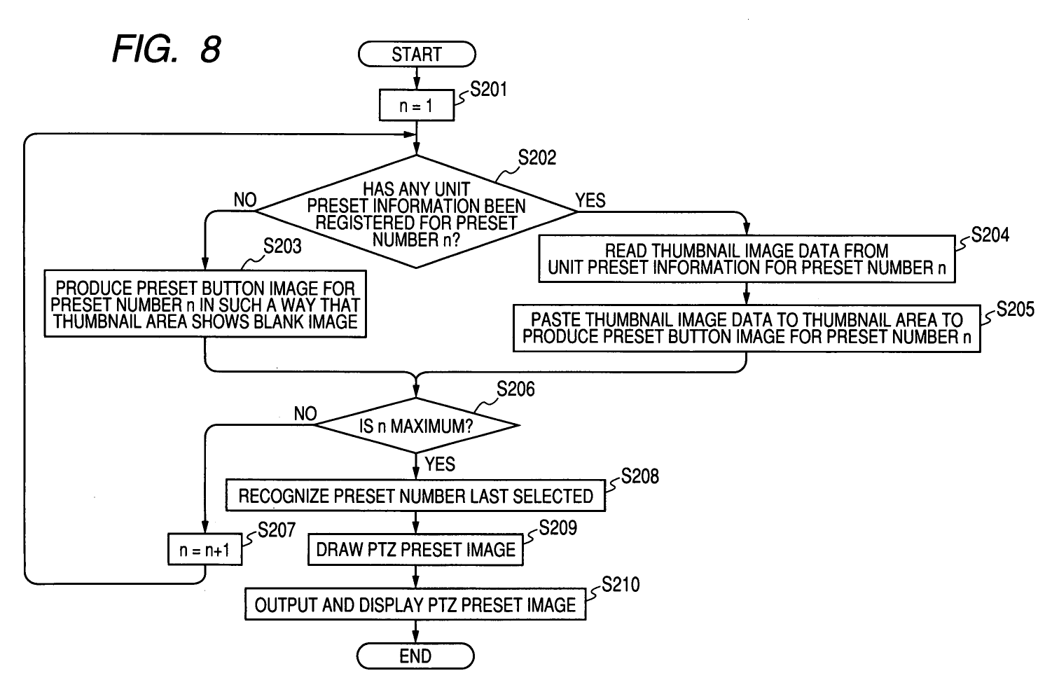

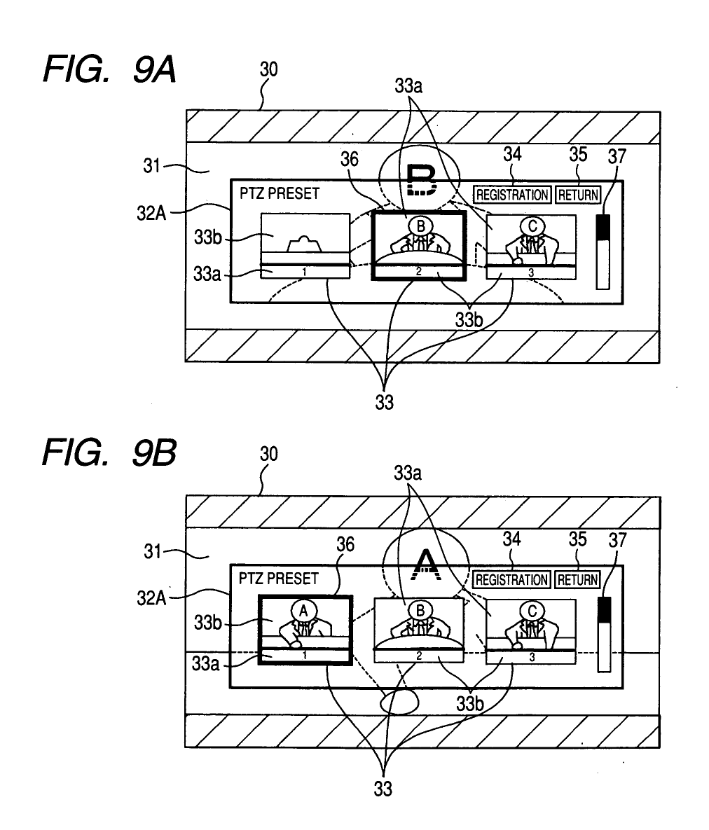

When the operation of displaying the PTZ preset image 32A is carried out, the near-end teleconference terminal apparatus 1 carries out initial display of the PTZ preset image 32A in the step S101. FIG. 8 shows processes for the initial display.

In FIG. 8, numerical one is first substituted into a variable n indicative of a preset number in the step S201.

In the next step S202, the preset information 19a in the storage unit 19 is accessed, and it is judged whether or not any unit preset information for the preset number n has been registered. When the judgment result is No, the control proceeds to the step S203, and an image for the preset button 33 that corresponds to the preset number n is produced in such a way that the thumbnail area 33b shows a blank image. On the other hand, when the judgment result is Yes, the control proceeds to the step S204, and the thumbnail image data contained in the unit preset information related to the preset number n in the preset information 19a is read. In the step S205, the thus read thumbnail image is pasted to the thumbnail area 33b to produce the image for the preset button 33 that corresponds to the preset number n.

After the step S203 or the step S205, the control proceeds to the step S206.

In the step S206, it is judged whether or not the variable n reaches the maximum. When the judgment result is No, it is judged that unprocessed preset numbers are left, and in the step S207, the variable n is incremented and the control returns to the step S202.

When the procedure from S203 to S205 have been carried out for all the preset numbers prepared in advance and hence the judgment result is Yes in the step S206, the control proceeds to the step S208.

In the step S208, the preset number that has been last selected and is now enabled is recognized.

In the step S209, the PTZ preset image 32A is drawn. That is, the images produced in the procedure described above for the preset buttons 33 that correspond to the preset numbers 1 to n are placed as the image background in the PTZ preset image 32A. Further, the image of the selection indication frame 36 is placed at the preset button 33 that corresponds to the preset number recognized in the step S208. Further, the registration button 34, the return button 35, and other fixed-shape images are placed. In this way, the PTZ preset image 32A, for example, shown in FIG. 4 is drawn. In the step S210, the video signal processing/display controller 11 is controlled to output and display the thus drawn PTZ preset image 32A on the display apparatus 4 in such a way that the PTZ preset image 32A is superimposed on the background image.

Referring back to FIG. 7, when the initial display of the PTZ preset image 32A is thus carried out in the step S101, it is judged in the step S102 whether or not any of the preset buttons 33 is selected as an operation on the PTZ preset image 32A. The preset buttons 33 are related to respective preset numbers. Selecting a preset button 33 therefore selects a preset number.

When any of the preset buttons (preset numbers) has been selected in the step S102 and hence the judgment result is Yes, the control proceeds to the step S103.

In the step S103, display control is carried out in which the selection indication frame 36 is moved and placed at the preset button 33 selected in the step S102.

In the step S104, it is judged whether or not any unit preset information 19a has been registered for the preset number that corresponds to the currently selected preset button 33 (the present preset number). When the judgment result is No, the control returns to the step S102, whereas when the judgment result is Yes, the procedure including the steps S105 and S106 is carried out.

In the step S105, the PTZ positional information contained in the unit preset information related to the present preset number is read from the preset information 19a stored in the storage unit 19. Subsequently, in the step S106, the pan mechanism 3a, the tilt mechanism 3b, and the zoom mechanism 2a are driven and controlled in such a way that they are positioned as indicated by the thus read PTZ positional information (PTZ drive control). In the PTZ drive control, for example, the controller 18 uses the pan, tilt, and zoom positions indicated by the PTZ positional information and the present positions of the pan mechanism 3a, the tilt mechanism 3b , and the zoom mechanism 2a to determine necessary amounts of movement in the pan direction, in the tilt direction, and in the zoom operation, and controls the PTZ drive controller 15 (the pan/tilt drive controller 16, the zoom drive controller 17) to achieve the above amounts of movement. The pan/tilt drive controller 16 and the zoom drive controller 17 produce drive signals in accordance with the instructed amounts of movement and drive the pan mechanism 3a, the tilt mechanism 3b, and the zoom mechanism 2a accordingly.

After the step S106, the control returns to the step S102.

When the judgment result is No in the step S102, it is judged in the step S107 whether or not any registration operation has been carried out.

First, when the judgment result is No in the step S107, the control proceeds to the step S108. For example, the pan direction, the tilt direction, and the zoom factor can be arbitrary changed by operating the remote controller, as described above. In the step S108, it is judged whether or not any of the pan direction, the tilt direction, and the zoom factor has been changed. When the judgment result is Yes, for example, the controller 18 determines necessary amounts of movement in response to the operation information obtained in the step S108 in accordance with the pan, tilt, and zoom changing operations, and carries out PTZ drive control accordingly. When the judgment result is No in the step S108, the control skips the step S109 and proceeds to the step S110.

In the step S110, it is judged whether or not there is an image deletion event that instructs to delete the PTZ preset image 32A. The image deletion event is obtained, for example, when an operation of deleting the PTZ preset image 32A is carried out, or when the PTZ preset image 32A remains displayed but no operation is carried out thereon for a fixed period.

When the image deletion event is obtained and hence the judgment result is Yes in the step S110, display control for deleting the displayed PTZ preset image 32A is carried out in the step S111. On the other hand, when the judgment result is No in the step S110, the control returns to the step S102.

On the other hand, when the judgment result is Yes in the previous step S107, the procedure including the step S112 and the following steps is carried out.

In the step S112, a still image is acquired and captured from the picked-up images picked up by the imaging apparatus 2 at the time of the registration operation. Thumbnail image data is then newly produced based on the still image.

In the step S113, PTZ information at the time of the registration operation is acquired, as in the step S106.

In the step S114, the thumbnail image data produced in the step S112 and the PTZ positional information acquired in the step S113 are used to produce unit preset information. In the next step S115, the unit preset information produced in the step S114 is registered as preset information. That is, in the preset information, the present preset number is related to the unit preset information produced in the step S114. In this process, when any unit preset information has been already related to the present preset number, the previous unit preset information is overwritten, which is update registration. On the other hand, when no unit preset information has been related to the present preset number, the new unit preset information is newly related to the present preset number, which is new registration.

In the step S116, in the PTZ preset image 32A presently outputted and displayed, the thumbnail image data that has been newly produced in the previous step S112 and then contained in the unit preset information is used to display the thumbnail image in the thumbnail area 33b of the preset button 33 that corresponds to the present preset number. After the step S116, the control returns to the step S102.

A second embodiment will be described below. In the second embodiment, based on the configuration of the first embodiment described above, a thumbnail image contained in unit preset information is automatically updated in response to a preset switching operation.

First, a description will be made of an example of state transition in response to an operation carried out on a PTZ preset image 32A according to the second embodiment with reference to FIGS. 9A and 9B. In FIGS. 9A and 9B, a near-end picked-up image 31 is displayed as the background image, as in FIGS. 4, 6A and 6B.

FIG. 9A shows a state in which the PTZ preset image 32A is displayed on the display screen 30, as in FIG. 4. In FIG. 9A, the thumbnail image tn displayed in the thumbnail area 33b of the preset button 33 that corresponds to the preset number 1 shows a zoomed-up seat where no conference participant is seated, because at the time of the last registration (update) for the preset number 1, no conference participant was seated on the seat within the imaging field of view picked up for the preset number 1.

In this case, it is assumed that the preset number that has been last selected and is now enabled is 2. Accordingly, the selection indication frame 36 is placed at the preset button 33 that corresponds to the preset number 2.

Thereafter, for example, assume that the conference has proceeded to some extent, during which a conference participant A has been seated on the seat within the imaging field of view that corresponds to the preset number 1. Thereafter, for example, further assume that the conference participant A is about to speak and the preset number 1 is called up.

In response to this operation, PTZ drive control is carried out in accordance with the PTZ information in the unit preset information that corresponds to the preset number 1, whereby the imaging field of view of the imaging apparatus 2 is moved to the seat position that corresponds to the preset number 1. At this point, the conference participant A seated on that seat is imaged and the picked-up image is transmitted to another teleconference terminal apparatus. Further, in this case, the near-end picked-up image 31 displayed on the near-end display apparatus 4 is also the seated conference participant A.

As described above, when a preset button 33 (preset number) is operated to call up another preset number different from the last selected present number, PTZ drive control that corresponds to the thus called up preset number is carried out, and the imaging field of view of the imaging apparatus 2 is changed accordingly, which is the same as the first embodiment.

In addition to this, in the second embodiment, when a preset number is called up to change the imaging field of view of the imaging apparatus 2, an image signal obtained through imaging using the changed imaging field of view is used to produce new thumbnail image data. In the unit preset information that corresponds to the called up preset number, the newly produced thumbnail image data is used to update the previous thumbnail image data.

The thus updated thumbnail image data is reflected in the PTZ preset image 32A. That is, as shown as the transition from FIG. 9A to 9B, at the timing when the imaging field of view is moved to the PTZ positions that correspond to the selected preset number 1, the thumbnail image tn in the thumbnail area 33b of the preset button 33 whose the preset number is 1 is changed to an image picked up by the imaging apparatus 2 at that point, that is, an image in which the conference participant A is seated on the seat.

As described above, in the second embodiment, the image picked up at the timing when change in PTZ positions in response to a preset call-up operation is completed is used to automatically update the thumbnail image that corresponds to the called-up preset number.

If such automatic update is not carried out, and the situation in the conference hall changes, for example, as conference participants enter or leave the conference hall, the user may need to carry out preset update registration whenever a change occurs if it is intended that the change is reflected in the thumbnail image tn for a selected preset button 33. On the other hand, in the second embodiment, the thumbnail image tn displayed on a preset button 33 is changed to the latest only by carrying out a preset changing operation, whereby the user's operation load is reduced.

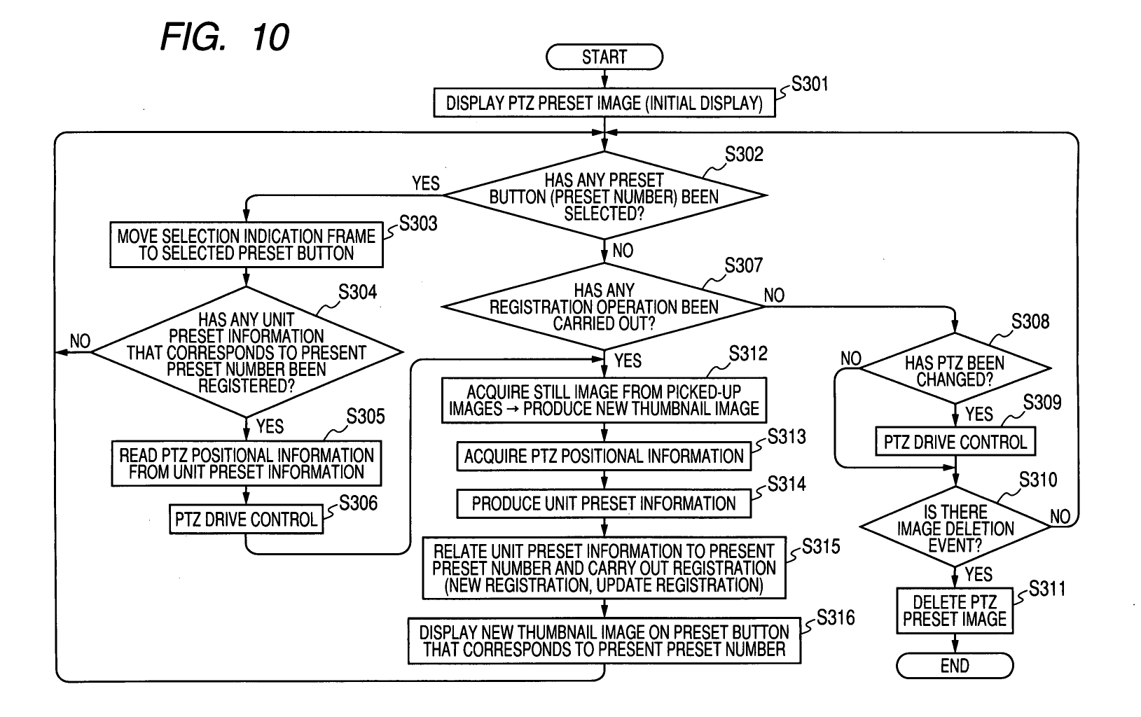

FIG. 10 shows an exemplary process procedure carried out by the near-end teleconference terminal apparatus 1 in relation to registration and call-up of PTZ preset information according to the second embodiment.

Each of the processes itself in the steps S301 to S316 shown in FIG. 10 is the same as the process in each of the steps S101 to S116 in FIG. 7 shown as the first embodiment described above. After the PTZ drive control is carried out in the step S306, however, the control does not return to the step S302 but proceeds to the step S312.

In this way, after the PTZ control is carried out in response to a preset number selecting operation (S301 to S306), the image picked up at that point is used to produce thumbnail image data. The thumbnail image data is used to update the unit preset information that corresponds to the selected preset image. At the same time, the thumbnail image data contained in the updated unit preset information is used to display the thumbnail image tn for the preset button 33 that corresponds to the selected preset number.

A third embodiment will be described below.

For example, even when the teleconference terminal apparatus 1 is installed and fixed in a single conference hall, participants may be different whenever a conference takes place. Considering such a situation, in the preset information 19a stored in the storage unit 19, keeping a thumbnail image tn contained in unit preset information after a conference is over hardly makes sense. Instead, for example, when the teleconference terminal apparatus 1 is activated and the PTZ preset image 32A is called up, conference participants may feel strange about a displayed thumbnail image tn picked up in a previous conference, which does not relate to the situation in the present conference hall at all.

To address the problem, in the third embodiment, when the near-end teleconference terminal apparatus 1 is activated, for a preset number that has been registered in the preset information 19a, the thumbnail image data in the unit preset information for the preset number is updated by using thumbnail image data picked up at the time of startup.

It is conceivable in many cases that preparation for starting a conference is being made when the teleconference terminal apparatus 1 is activated. Updating thumbnail image data at the time of startup therefore prevents a thumbnail image that corresponds to a previous conference from being displayed when the PTZ preset image 32A is displayed.

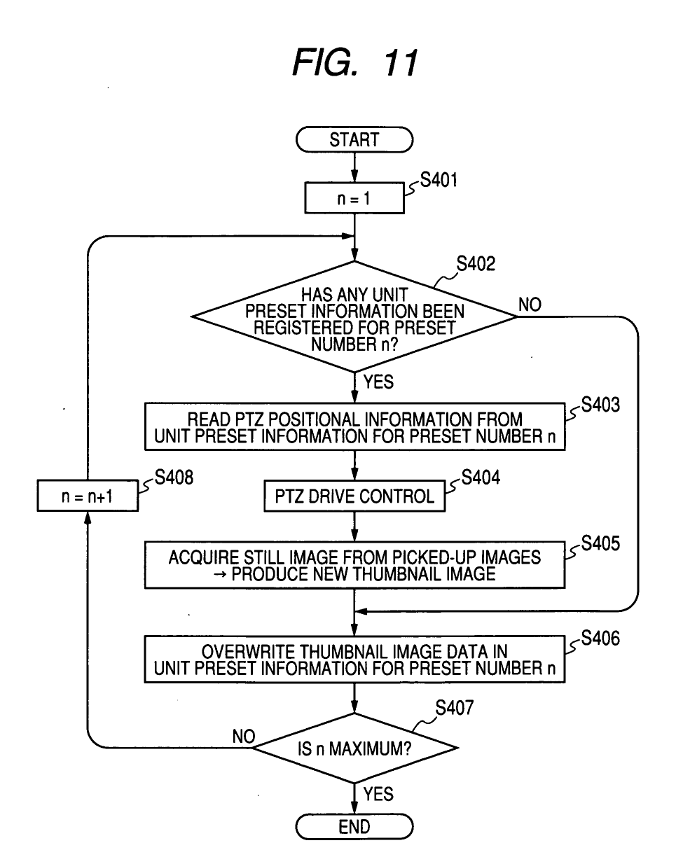

FIG. 11 is a flowchart showing a procedure carried out by the teleconference terminal apparatus 1 to update thumbnail image data according to the third embodiment.

In the step S401, numerical one is first substituted into the variable n that corresponds to a preset number.

In the next step S402, in the preset information 19a stored in the storage unit 19, it is judged whether or not any unit preset information has been registered for the preset number n. When the judgment result is No, the control skips the steps S403 to S406 and proceeds to the step S407, whereas when the judgment result is Yes, the control proceeds to the steps S403 to S406.

In the step S403, in the preset information 19a, PTZ positional information is read from the unit preset information related to the preset number n, and in the step S404, PTZ drive control based on the PTZ positional information is carried out.

At the timing when the PTZ drive control is completed in the step S404 and the imaging field of view of the imaging apparatus 2 that corresponds to the preset number n is fixed, in the step S405, a still image is acquired from picked-up images to newly produce thumbnail image data. Further, in the step S406, the thumbnail image data produced in the step S405 overwrites the previous thumbnail image data in the unit preset information that corresponds to the preset number n.

A fourth embodiment will be described below.

In the fourth embodiment, an operation on the PTZ preset image 32A displayed in the format described above allows the near-end teleconference terminal apparatus to carry out PTZ drive control for a far-end teleconference terminal apparatus with which the near-end teleconference terminal apparatus communicates as well as registration of preset information (new registration, update registration) that controls the imaging field of view of the far-end teleconference terminal apparatus 1. In relation to FIG. 1, for example, the near-end teleconference terminal apparatus corresponds to the teleconference terminal apparatus 1-1 in the place A, and the far-end teleconference terminal apparatus corresponds to the teleconference terminal apparatus 1-2 in the place B.

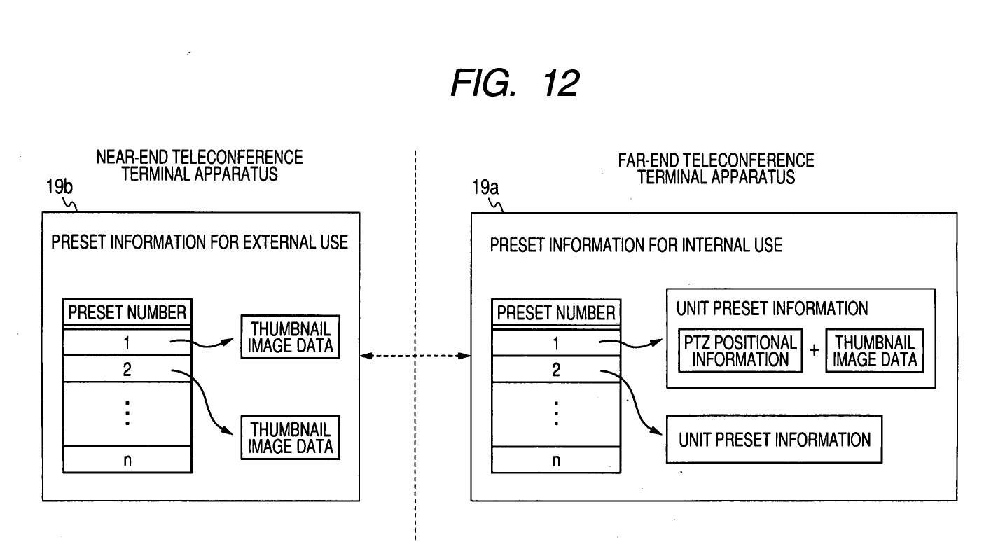

FIG. 12 shows an exemplary structure of preset information according to the fourth embodiment.

First, in the far-end teleconference terminal apparatus 1-2, the preset information 19a for the far-end teleconference terminal apparatus 1-2 (referred to as preset information for internal use in this description) has the same configuration as that shown in FIG. 5 and is held in the storage unit 19. In the far-end teleconference terminal apparatus 1-2, the PTZ drive control on its imaging apparatus 2-2 based on the preset information for internal use 19a and registration and update of the preset information for internal use 19a can be carried out in the same manner described in the above embodiments.

In addition to the above, according to the fourth embodiment, the near-end teleconference terminal apparatus 1 has preset information for external use 19b held in the storage unit 19.

The preset information for external use 19b allows the near-end teleconference terminal apparatus 1 to register and update the preset information for internal use 19a in the far-end teleconference terminal apparatus 1 and carry out other control operations. In the preset information for external use 19b, as illustrated, a preset number is related to thumbnail image data. In other words, PTZ positional information is removed from unit preset information related to a preset number, and only thumbnail image data is left.

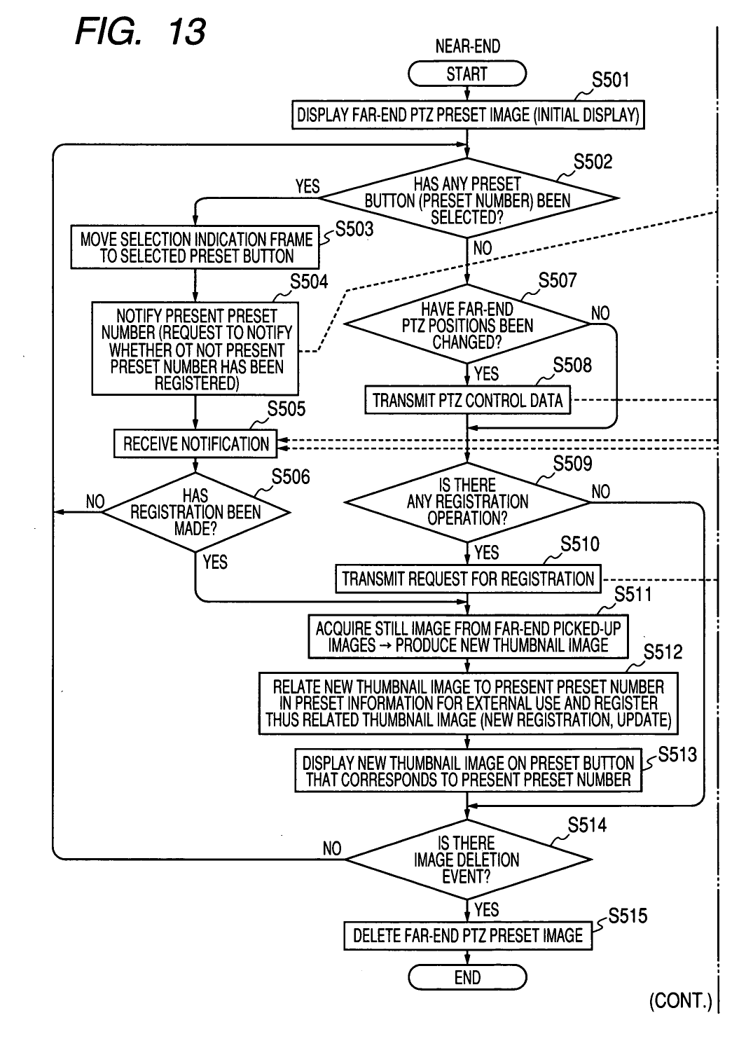

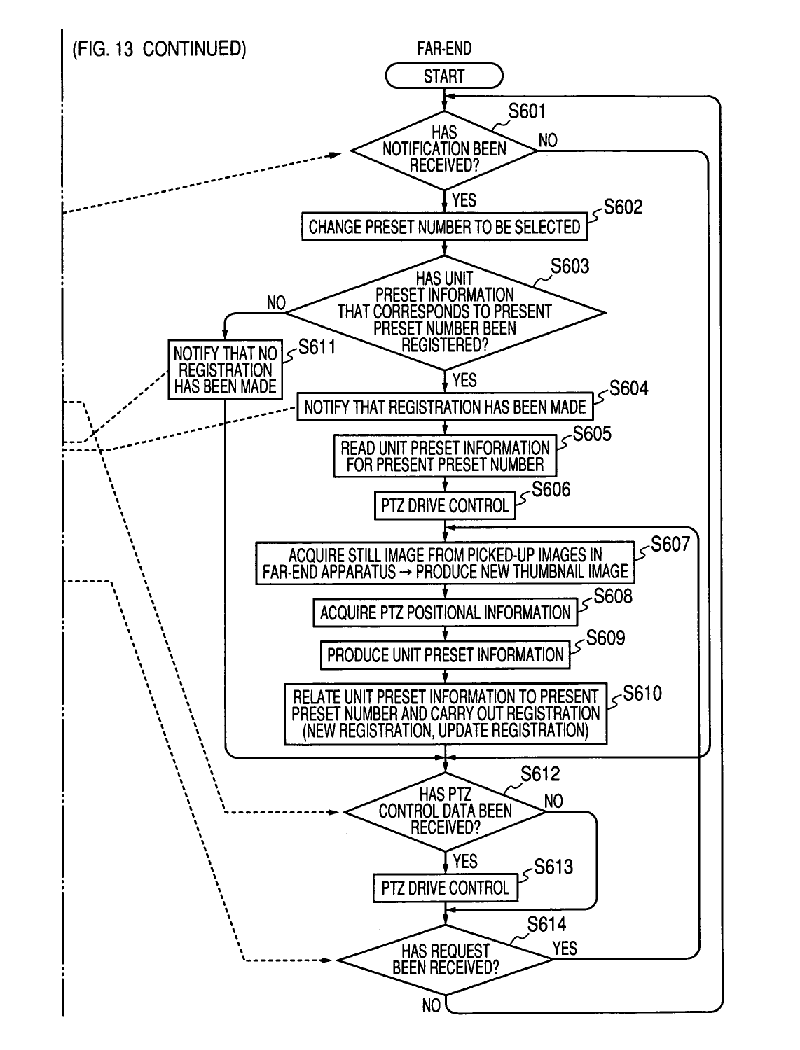

FIG. 13 shows an exemplary procedure carried out by the near-end teleconference terminal apparatus 1 and the far-end teleconference terminal apparatus 1 in accordance with the fourth embodiment. In FIG. 13, in a manner similar to the second embodiment, when the near-end apparatus changes the PTZ preset information in the far-end apparatus, the thumbnail image data in the preset information for internal use 19a in the far-end teleconference terminal apparatus 1 is updated.

Now, assume that, for example, an operation on the remote controller 5 or other components instructs the near-end teleconference terminal apparatus 1 to display a far-end preset image that is a PTZ preset image for manipulating PTZ preset information in the far-end teleconference terminal apparatus 1.

In response to this, in the step S501, the near-end teleconference terminal apparatus 1 displays the far-end PTZ preset image on the near-end display apparatus 4. In this process, the preset information for external use 19b held in the storage unit 19 of the near-end teleconference terminal apparatus 1 is used to carry out display control similar to that shown in FIG. 8. In this way, the far-end PTZ preset image is displayed in the basic format, for example, similar to that shown in FIG. 4, and the preset button 33 that corresponds to a preset number that has been already registered shows a thumbnail image tn based on thumbnail image data contained in the preset information for external use 19b.

In the next step S502, it is judged whether or not any preset button 33 is selected, for example, as in the step S302 shown in FIG. 10 described above.

When the judgment result is Yes, in the step S503, display control is carried out in which the selection indication frame 36 is moved to the selected preset button 33, as in the step S303 shown in FIG. 10.

In the next step S504, communication control is carried out in which the far-end teleconference terminal apparatus 1 is notified of the preset number that corresponds to the preset button 33 selected in the step S502 (present preset number). The notification of the present preset number is transmitted along with a request asking that the far-end teleconference terminal apparatus 1 return notification of whether or not the present preset number has been registered.

In response to the notification of the present preset number in the step S504, the far-end teleconference terminal apparatus 1 transmits notification indicating whether or not any unit preset information that corresponds to the notified present preset number has been registered in the preset information for internal use 19a, as will be described later.

The near-end teleconference terminal apparatus 1 receives the notification in the step S505, and judges in the next step S506 whether or not the notification indicates that unit preset information has been registered. When the judgment result is No, the control returns to the step S502, whereas when the judgment result is Yes, the control proceeds to the step S511. The procedure after the step S511 will be described later. Proceeding from the step S506 to the step S511 allows thumbnail image data registered in the preset information for internal use 19a to be updated after the preset selection in a manner similar to the second embodiment.

When the judgment result of No in the step S502, it is judged in the step S507 whether or not the PTZ positions of the imaging apparatus 2-2 and the mounting base 3-2 in the far-end teleconference terminal apparatus 1-2 have been changed.

When the judgment result is No, the control skips the step S508 and proceeds to the step S509. On the other hand, when the judgment result is Yes, in the step S508, the near-end teleconference terminal apparatus 1-1 transmits PTZ control data to the far-end teleconference terminal apparatus 1-2. The PTZ control data, for example, indicate the amounts of movement in the pan, tilt, and zoom directions in accordance with the PTZ operation. The far-end teleconference terminal apparatus 1-2 that has received the PTZ control data carries out PTZ drive control on the imaging apparatus 2-2, as will be described later. In this way, the near-end teleconference terminal apparatus 1-1 can control the panning, tilting, and zooming in the far-end teleconference terminal apparatus 1-2.

In the next step S509, it is judged whether or not registration for the presently selected preset number is carried out on the far-end PTZ preset image. When the judgment result is No, the control proceeds to the step S514, whereas when the judgment result is Yes, the procedure from the steps S510 to S513 are carried out, and the control proceeds to the step S514.

In the step S510, a request for registration in response to the current registration operation is first transmitted to the far-end teleconference terminal apparatus 1-2. In response to the request, as will be described later, the far-end teleconference terminal apparatus 1-2 registers and updates the unit preset information related to the present preset number in the preset information for internal use 19a.

In this process, the far-end teleconference terminal apparatus 1-2 transmits an image signal containing motion images picked up by the far-end imaging apparatus 2-2 to the near-end teleconference terminal apparatus 1-1.

In the step S511, a still image is acquired from the far-end picked-up images thus transmitted as an image signal to newly produce thumbnail image data. In the next step S512, the present preset number in the preset information for external use 19b stored in the near-end teleconference terminal apparatus 1-1 is related to the thumbnail image data produced in the step S511 and the thus related thumbnail image data is registered. In the step S513, the thus related thumbnail image data is used to newly display a thumbnail image tn on the preset button 33 that corresponds to the present preset number in the far-end PTZ preset image being presently displayed.

The procedure from the step S506 to the steps S511 to S513 is similar to that in the second embodiment. When the present preset number has been already registered and the preset number (preset button) is changed, thumbnail image registration is updated and, in response to this, the thumbnail image displayed in the thumbnail area 33b of the preset button 33 that corresponds to the present preset number is updated.

In the step S514, it is judged whether or not there is an image deletion event. When the judgment result is Yes, the control proceeds to the step S515, and the displayed far-end PTZ preset image is deleted. On the other hand, when the judgment result is No in the step S514, the control returns to the step S502.

A description will now be made of an exemplary procedure carried out by the far-end teleconference terminal apparatus 1-2.

First, it is judged in the step S601 whether or not the notification of the present preset number (request to notify the present preset number has been registered or not) transmitted from the near-end teleconference terminal apparatus 1-1 in the step S504 has been received. When the judgment result is No, the control proceeds to the step S612. On the other hand, when the judgment result is Yes, the control proceeds to the step S602, and the preset number to be selected (to be the present preset number) is first changed to the preset number indicated by the received notification. Thereafter, in the step S603, the preset information for internal use 19a held in the storage unit 19 in the far-end teleconference terminal apparatus 1-2 is accessed, and it is judged whether or not any unit preset information has been registered for the present preset number. When the judgment result is No, in the step S611, notification indicating that no unit preset information has been registered is transmitted as a response to the request to notify unit preset information has been registered or not received in the step S601, and the control proceeds to the step S612. On the other hand, when the judgment result is Yes, notification indicating that unit preset information has been registered is transmitted in the step S604.

After the step S604, the procedure after the step S605 is carried out.

In the step S605, PTZ positional information is read from the unit preset information related to the present preset number in the preset information for internal use 19a, and PTZ drive control is carried out in the step S606. As a result, the imaging field of view is changed in the far-end teleconference terminal apparatus 1-2 in accordance with the preset call-up operation in the near-end teleconference terminal apparatus 1-1.

The following steps S607 to S610 are similar to the steps S312 to S315 shown in FIG. 10. That is, in the step S607, a still image is acquired from the images picked up by the imaging apparatus 2-2 connected to the same far-end teleconference terminal apparatus 1 to newly produce thumbnail image data. In the step S608, PTZ positional information that corresponds to the imaging field of view set in the present imaging apparatus 2-2 is acquired. In the step S609, the thumbnail image data and the PTZ positional information described above are used to produce unit preset information. In the step S610, the unit preset information that corresponds to the present preset number is newly registered or updated.

In the next step S612, it is judged whether or not the PTZ control data transmitted from the near-end teleconference terminal apparatus 1-1 has been received. When the judgment result is Yes, in the step S613, PTZ drive control on the mounting base 3-2 and the imaging apparatus 2-2 is carried out based on the received PTZ information. When the judgment result is No, the control skips the step S613 and proceeds to the step S614.

In the step S614, it is judged whether or not the request for registration transmitted from the near-end teleconference terminal apparatus 1-1 has been received. When the judgment result is Yes, the control proceeds to the step S607. On the other hand, when the judgment result is No, the control returns to the step S601.

The process procedures shown in the flowcharts in FIGS. 8, 10, and 13 can be considered as those obtained by executing a program in the CPU that forms the controller 18. It is conceivable that the program is written and stored, for example, in the ROM that forms the controller 18 or the storage unit 19 at the time of manufacture, or first stored in a removable storage medium and then stored in the storage unit 19 or other storage components by installing (including updating) the program from the storage medium. It is also conceivable that the program is installed under the control of another host apparatus via a data interface. It is further conceivable that the program is stored in a storage unit in a server or other apparatus on a network and then acquired, for example, by downloading the program from the server via the network.

The exemplary specific display format in the GUI (Graphic User Interface) as the PTZ preset image, the form of operations on the PTZ preset image, and other examples should not be limited to those described above, but may be changed as appropriate. For example, for the display format, the classification of preset information shown for each preset button 33 is not necessarily a preset number, but may be, for example, an alphabetic character.

While the imaging field changing mechanisms are the pan mechanism 3a, the tilt mechanism 3b, and the zoom mechanism 2a in the above embodiments, at least one of the above mechanisms may be included.

Further, for example, the configuration of the teleconference system and the internal configuration of the teleconference terminal apparatus 1 shown in FIGS. 1 and 2 may be changed as appropriate.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging control apparatus comprising:
preset information management means for holding and managing unit preset information including positional information indicative of the position of an imaging field changing mechanism that changes the imaging field of view of an imaging unit, and reference image data, the preset information management means producing and holding, as a registration process in response to a registration instruction, unit preset information including positional information indicative of the position of the imaging field changing mechanism when the registration instruction is issued and reference image data related to the positional information and produced based on an image signal obtained through imaging performed by the imaging unit when the registration instruction is issued;
operation screen display control means for controlling display of an operation image used to select among preset items that correspond to respective sets of unit preset information held in the preset information management means, the operation screen display control means displaying and presenting, for each of the preset items, the reference image data contained in the corresponding unit preset information on the operation screen; and
drive control means for carrying out drive control for changing the position of the imaging field changing mechanism, the drive control means carrying out the drive control in such a way that when a preset item is selected and entered on the operation screen, the imaging field changing mechanism is positioned as indicated by the positional information in the unit preset information that corresponds to the selected and entered preset item.

2. The imaging control apparatus according to claim 1,
wherein the preset information management means newly produces, as the registration process, reference image data based on an image signal obtained through imaging performed by the imaging unit when the drive control means drives the imaging field changing mechanism to the position indicated by the positional information contained in the unit preset information that corresponds to the selected and entered preset item, and updates the unit preset information that corresponds to the selected and entered preset item in such a way that the previous reference image data is changed to the newly produced reference image data.

3. The imaging control apparatus according to claim 2,
wherein at the time of startup, the drive control means drives and controls the imaging field changing mechanism to be positioned as indicated by the positional information contained in the unit preset information held at the time of startup in the preset information management means, and
the preset information management means newly produces, as the registration process, reference image data based on an image signal obtained through imaging performed by the imaging unit when the drive control means drives the imaging field changing mechanism to the position indicated by the positional information contained in a set of unit preset information, and updates the unit preset information that corresponds to the selected and entered preset item in such a way that the previous reference image data is changed to the newly produced reference image data.

4. The imaging control apparatus according to claim 1,
wherein the preset information management means holds and manages unit preset information for an imaging unit provided in an communication counterpart in a teleconference system, the unit preset information related to at least reference image data, and produces and holds, as a registration process in response to a registration instruction, communication counterpart's unit preset information related to reference image data produced based on an image signal obtained through imaging performed by the counterpart's imaging unit when the registration instruction is issued,
the operation screen display control means controls display of an operation screen used to select among preset items that correspond to respective sets of counterpart's unit preset information held in the preset information management means, and displays and presents, for each of the preset items, the reference image data contained in the corresponding unit preset information on the operation screen, and
the imaging control apparatus further comprises counterpart's imaging field control means for changing the imaging field of view of the far-end imaging unit in such a way that when a preset item is selected and entered on the operation screen, the imaging field of view is positioned in accordance with the positional information held in the near-end or the far-end apparatus in accordance with the counterpart's unit preset information that corresponds to the selected and entered preset item.

5. An imaging control method comprising the steps of:
holding and managing unit preset information including positional information indicative of the position of an imaging field changing mechanism that changes the imaging field of view of an imaging unit that forms a teleconference system, and reference image data, the preset information management step, as a registration process in response to a registration instruction, producing unit preset information including positional information indicative of the position of the imaging field changing mechanism when the registration instruction is issued and reference image data related to the positional information and produced based on an image signal obtained through imaging performed by the imaging unit when the registration instruction is issued and storing the produced unit preset information in a storage unit;
controlling display of an operation image used to select among preset items that correspond to respective sets of unit preset information held by using the preset information management step, the operation screen display control step displaying and presenting, for each of the preset items, the reference image data contained in the corresponding unit preset information on the operation screen; and
carrying out drive control for changing the position of the imaging field changing mechanism, the drive control step carrying out the drive control in such a way that when a preset item is selected and entered on the operation screen, the imaging field changing mechanism is positioned as indicated by the positional information in the unit preset information that corresponds to the selected and entered preset item.

6. An imaging control apparatus comprising:
a preset information management section holding and managing unit preset information including positional information indicative of the position of an imaging field changing mechanism that changes the imaging field of view of an imaging unit, and reference image data, the preset information management section producing and holding, as a registration process in response to a registration instruction, unit preset information including positional information indicative of the position of the imaging field changing mechanism when the registration instruction is issued and reference image data related to the positional information and produced based on an image signal obtained through imaging performed by the imaging unit when the registration instruction is issued;
an operation screen display control section controlling display of an operation image used to select among preset items that correspond to respective sets of unit preset information held in the preset information management section, the operation screen display control section displaying and presenting, for each of the preset items, the reference image data contained in the corresponding unit preset information on the operation screen; and
a drive control section carrying out drive control for changing the position of the imaging field changing mechanism, the drive control section carrying out the drive control in such a way that when a preset item is selected and entered on the operation screen, the imaging field changing mechanism is positioned as indicated by the positional information in the unit preset information that corresponds to the selected and entered preset item.
